(19) United States
(12) Patent Application Publication
(10) Pub. No.: US 2013/0125046 A1
(43) Pub. Date: May 16, 2013

(54) Dynamic non-interruptive visual image isolation

(71) Applicants: Troy A. Gaul, Shoreview, MN (US); Christopher P. Clevenger, San Francisco, CA (US)

(72) Inventors: Troy A. Gaul, Shoreview, MN (US); Christopher P. Clevenger, San Francisco, CA (US)

(73) Assignee: Adobe Systems Incorporated, San Jose, CA (US)

(21) Appl. No.: 11/326,848

(22) Filed: Jan. 6, 2006

(51) Int. Cl. G06F 3/0484

(52) U.S. Cl. CPC G06F 3/0484
USPC 715/790

(57) ABSTRACT

Dynamic non-interruptive visual image isolation is described, including providing an overlay window over an interface displaying the image, the interface being configured to display the image and the overlay window being configured to have a cutout disposed over the image, receiving dimming input, the dimming input being associated with an application, and adjusting transparency of the overlay window in response to the dimming input, the transparency being determined without affecting the application.

### FIELD OF THE INVENTION

The present invention relates generally to software and software development. More specifically, dynamic non-interruptive visual image isolation is described.

### BACKGROUND

Computer programs or applications (“applications”) are developed using various techniques. To enhance a user experience, a conventional development technique involves viewing an image in isolation or apart from other user interface items (e.g., dashboard, menus, buttons, controls, graphical elements, and the like). By viewing an image during the development of an application, webpage, or document, a user can preview the appearance of the image and make modifications that enhance the user experience. For example, a user (e.g., document author, creative editor, software developer, or an individual application user) may be working on a particular page of a website or document that contains various images. During creation, editing, or other operations, he may want to isolate one or more of the images to determine whether the image should be modified or edited. However, conventional development techniques that allow for image isolation are often problematic.

Some conventional techniques provide various limited abilities to isolate an image, but often create development difficulties, inefficiencies, or workflow obstacles. For example, some conventional techniques allow for image isolation, but disable the functionality of the application that the user is using to develop a webpage or document. This may prevent the user from making desired changes or modifications to the image or other aspects of the presentation environment (e.g., application, webpage, document, and the like). Another example allows for image isolation, but is typically performed in the context of a static slideshow. Conventional slideshow techniques such as PowerPoint developed by Microsoft Corporation of Redmond, Wash., allow for embedding images into a slide, but functionality is completely disabled and a user is forced to interrupt his workflow by viewing the slideshow in a different application altogether. With the exception of the slideshow application (e.g., PowerPoint), all other application functionality has been disabled and, more importantly, the workflow perspective of the user has been interrupted.

Thus, what is needed is a solution for isolating visual images without the limitations of conventional implementations.

### BRIEF DESCRIPTION OF THE DRAWINGS

Various embodiments are disclosed in the following detailed description and the accompanying drawings:

FIG. 1 illustrates an exemplary system for isolating an image, in accordance with an embodiment;

FIG. 2A illustrates an exemplary user interface illustrating isolation of an image, in accordance with an embodiment;

FIG. 2B illustrates an exemplary user interface illustrating isolation of an image with partial dimming, in accordance with an embodiment;

FIG. 2C illustrates an exemplary user interface illustrating isolation of an image with full dimming, in accordance with an embodiment;

FIG. 2D illustrates an exemplary user interface illustrating isolation of an image with full dimming and selective illumination, in accordance with an embodiment;

FIG. 3 illustrates an exemplary process for isolating an image, in accordance with an embodiment;

FIG. 4A illustrates an exemplary process for providing an overlay window, in accordance with an embodiment;

FIG. 4B illustrates an exemplary process for adjusting transparency of an overlay window, in accordance with an embodiment;

FIG. 5 illustrates an alternative exemplary process for isolating an image, in accordance with an embodiment; and

FIG. 6 is a block diagram illustrating an exemplary computer system suitable for dynamic non-interruptive visual image isolation, in accordance with an embodiment.

### DETAILED DESCRIPTION

Various embodiments may be implemented in numerous ways, including as a system, a process, an apparatus, or as computer program instructions included on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

Dynamic non-interruptive visual image isolation is described, including embodiments that may be varied in system design, implementation, and execution. The described techniques may be implemented as software (i.e., computer programs or applications) developed using structured and unstructured programming or formatting languages, standards, and protocols such as C++, .Net, Java, C, Objective-C, XML, HTML, WSDL, and others. The described techniques enable a user to dynamically isolate an image (e.g., graphic, text, video, and other content or elements presented on a user interface (i.e., screen, display, and the like)) without disabling underlying application functionality. Although images may be isolated in some examples, other types of content (text, content, graphics, video, blocks of text, and other content) may be dynamically isolated using the described techniques. In some examples, functionality may include methods, operations, processes, or sub-processes performed by an application used by a user when isolating an image. Further, the described techniques enable a user to work with images without experiencing a workflow interruption or requiring a complete shift of applications in order to view or preview a document, page, image, or other item. The described techniques selectively dim background “lighting” by modifying the transparency or opacity of an overlay window in response to user input, which may be implemented using a keyboard or other I/O device, including manipulation of graphical icons or images (e.g., widget; further described below) that provide input to the image isolation functionality. The described techniques may be varied in implementation and design and are not limited to the descriptions provided.

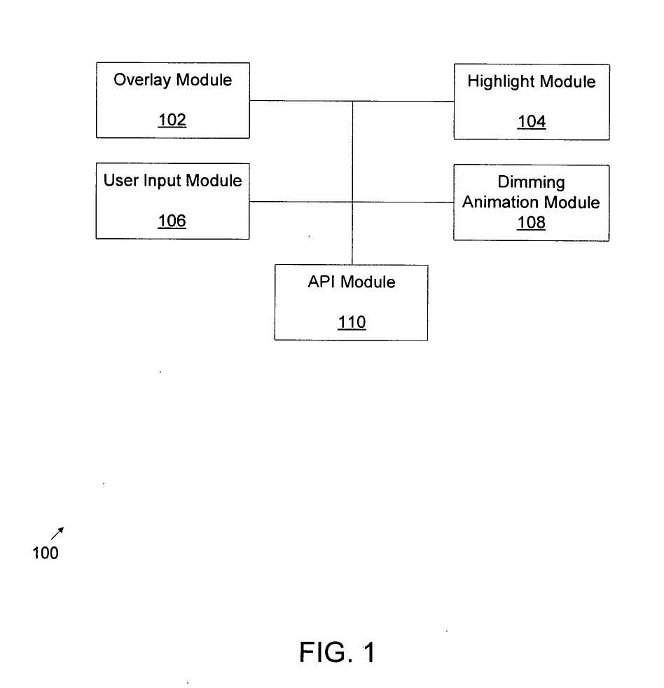

FIG. 1 illustrates an exemplary system for isolating an image, in accordance with an embodiment. Here, image isolation system 100 includes overlay module 102, highlight module 104, user input module 106, dimming animation module 108, and application programming interface (API) module 110. In some examples, image isolation system 100 may include more or fewer modules apart from those shown in the above example.

In some examples, overlay module 102 may be configured to provide an overlay window over a graphical user interface (hereafter “interface”) and content such as images, text, icons, buttons, or other graphical elements on a display screen. An overlay window may cover a display, screen, or interface (hereafter “interface”) with other items shown. However, overlay module 102 may be configured to render an overlay window with other graphical elements on an interface. The overlay window may be provided by rendering pixel data for the overlay window. In other examples, an overlay window may be presented differently. When a user provides input using a keystroke on a keyboard (e.g., pressing the “L” key to dim or raise the “lighting,” i.e., the transparency of an overlay window is configured to create the appearance of different levels of light, shade, and dimming), input may be provided to system 100 to selectively isolate one, some, or all of the images on the interface. In other examples, other content (e.g., text, graphics, video, text blocks, and others) may be dynamically isolated instead of images. For example, a page in an authoring application such as InDesign® produced by Adobe Systems Incorporated of San Jose, Calif., may be isolated using system 100. As another example, a video-authoring application may be implemented with system 100 to dynamically isolate a video display on an interface. Many other types of content may be used apart from images and are not limited to the examples provided.

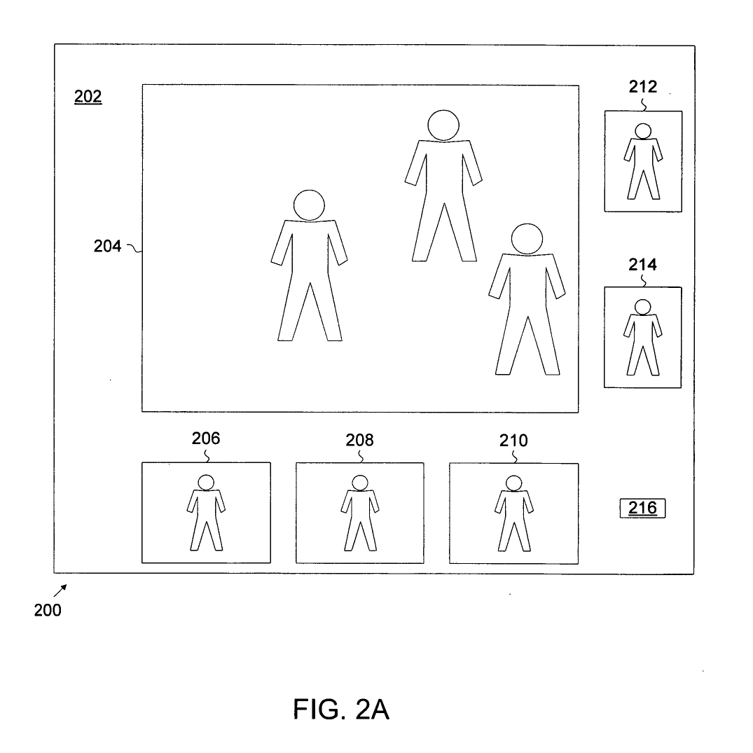

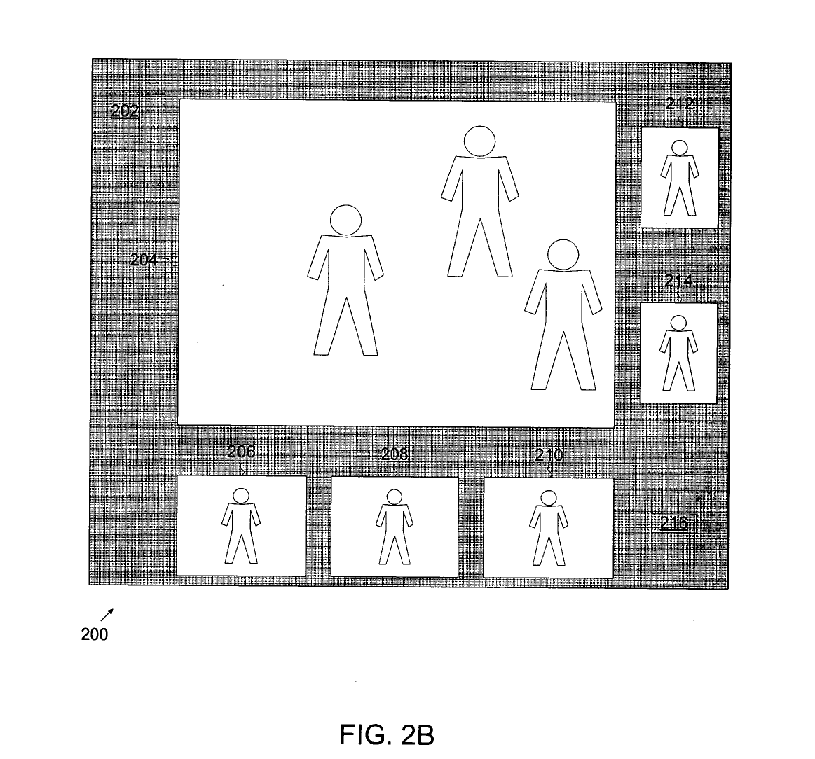

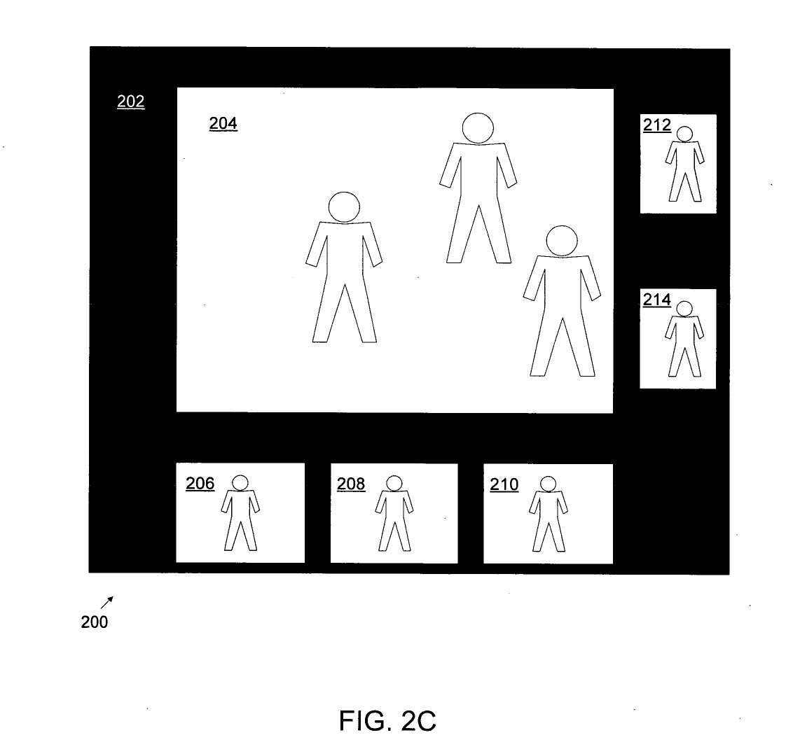

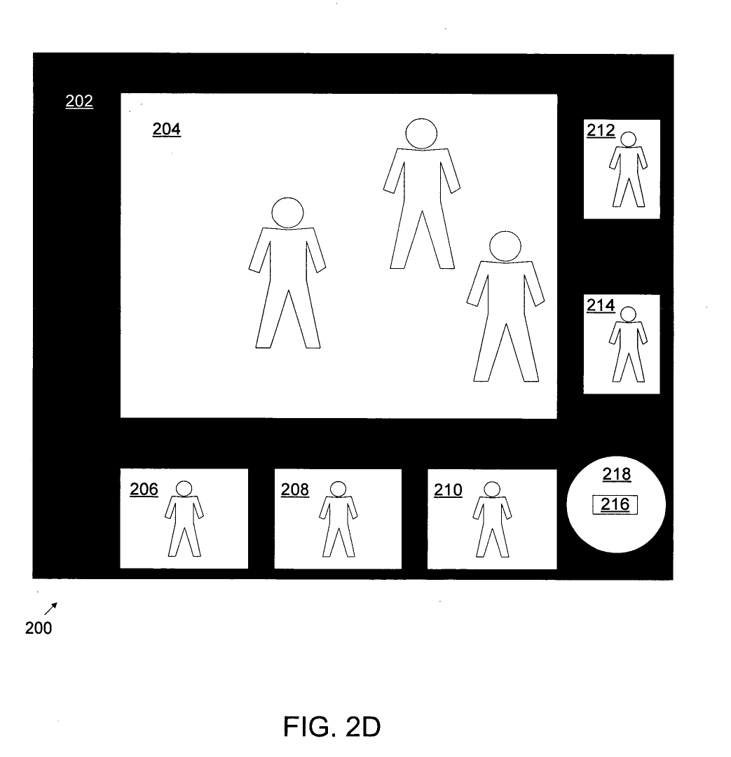

In some examples, one or more keys may be configured for use to provide dimming input to system 100. If a given key (e.g., “L” key) is pressed, dimming input may be provided to modules 102-110 signaling a transparency level for an overlay window (as described in greater detail below in connection with FIG. 2). A key may also be configured to provide different dimming inputs at different times throughout the creative editing process. For example, pressing a key once may completely dim the background content surrounding the images on the interface. In another example, pressing a key may cause a transparency level of an overlay window to be adjusted in 10% increments, such as dimming or increasing the opacity in 10% increments with each keystroke. When a keystroke increases the transparency level of an overlay window to 100% opacity (i.e., fully and completely dark, black, solid, or non-transparent), then a subsequent keystroke of the same or different key may cause the transparency level of the overlay window to reset to 0% opacity (i.e., completely clear or transparent). In other examples, different keys may be configured to transmit or send different dimming input signals to system 100.

As an example, numbered keys “1” through “0” may be used to provide dimming input that signals increasing or decreasing the transparency level of an overlay window in 10% increments. As another example, the “ESC” key may be configured to restore the transparency level of an overlay window to complete transparency. In still other examples, numbered keys “1” through “9” may be configured to increase or decrease the transparency level of an overlay window in 10% opacity increments, but the “0” key may be configured to restore the overlay window to full transparency. The dynamic image isolation functionality described for system 100 may be application-wide or defined for specific functional aspects of an application-in-use. API module 110 provides data from an underlying application (not shown) that allows selective dimming or dynamic image isolation without functionality loss.

Here, API module 110 may be implemented to gather data from an application-in-use that includes current light state, opacity, or other data that may be used to create a light state for an interface. API module 110 may be configured to exchange data with various applications to support the “dimming” functionality of system 100. In some examples, API module 110 retrieves data that determines when the transparency level of an overlay window (as described below in connection with FIG. 2) should be restored to full transparency. Automatic restoration to full transparency may occur when commands are executed that invoke full transparency or, from a user's perspective, “turn the lights back on.” API module 110 may also act as a registry for applications that are executed so that when a user switches between various applications, the image isolation functionality is accessible in the current application-in-use. In other words, applications-in-use register with API module 110 to ensure that dynamic image isolation functionality, as described above, are available for use. System 100 and modules 102-110 may be implemented differently using a variety of techniques, architectures, and are not limited to the descriptions provided above.

FIG. 2A illustrates an exemplary user interface illustrating isolation of an image, in accordance with an embodiment. Here, interface 200 includes overlay window 202, images 204-214, and functionality control 216. In some examples, overlay window 202 is overlaid on top of interface 200, with images 204-214 being displayed below. In other examples, interface 200, overlay window, and images 204-214 may be implemented differently and are not limited to the described embodiments. Also, functionality control 216 is illustrative of a button, icon, graphic, menu, field, or other control feature that may be used to represent functionality of an application being used by a user to preview images 204-214. For example, functionality control 216 may be a button used to publish images 204-214 on a website, but is presented on interface 200 and may be considered as part of the background of window 202. Functionality control 216 may be varied in implementation, function, structure, and other characteristics, and is not limited to the above description.

When overlay window 202 is transparent, images 204-214 are visible. As user input is received, the transparency of overlay window 202 is adjusted, which may appear as dimming of lighting surrounding images 204-214. Dimming may occur in varying degrees of isolation. Although overlay window 202 is laid on top of interface 200, implementation may occur using a variety of techniques. For example, interface 200, overlay window 202, and images 204-214 may be implemented using various graphic rendering techniques, tools, and applications. Pixel data for interface 200, overlay window 202, and images 204-214 may be rendered on a screen or display to give the appearance of dimming or brightening overlay window 202 when dimming input is received by system 100 (FIG. 1). In other examples, interface 200, overlay window 202, and images 204-214 may be implemented differently.

FIG. 2B illustrates an exemplary user interface illustrating isolation of an image with partial dimming, in accordance with an embodiment. Here, the transparency level of overlay window 202 has been modified to present the appearance of partial dimming. In response to user input, the transparency level of overlay window 202 has been decreased to darken the background surrounding images 204-214. Images 204-214 remain fully visible, but functionality control 216 appears partially dim because it also belongs to the background (i.e., overlay window 202). Functionality control 216 also remains fully functional and available to the user, despite the dimming of overlay window 202.

FIG. 2C illustrates an exemplary user interface illustrating isolation of an image with full dimming, in accordance with an embodiment. Here, the transparency level of overlay window 202 has been fully decremented to zero, completely blocking out the background surrounding images 204-214 and functionality control 216. Although fully blocked out, functionality control 216 remains available to a user. The underlying functionality of the application that is represented by the graphical icon or representation of functionality control 216 also remains available to a user.

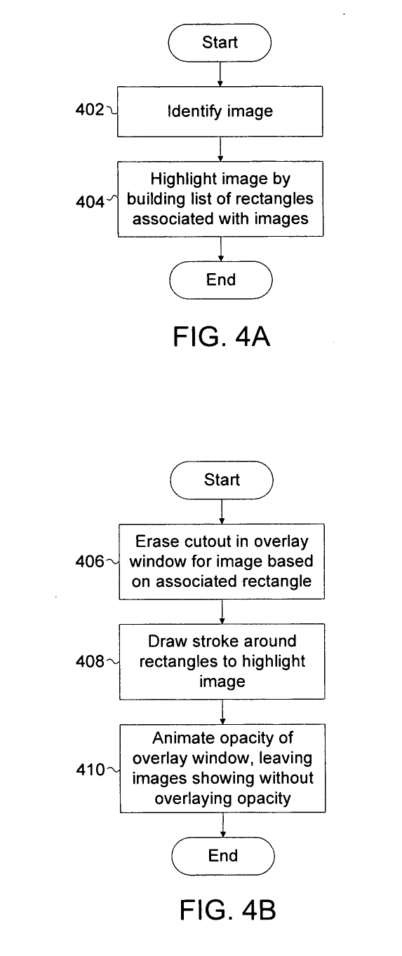

FIG. 2D illustrates an exemplary user interface illustrating isolation of an image with full dimming and selective illumination, in accordance with an embodiment. Here, with a fully dimmed overlay window 202, underlying functionality remains available to a user. In some examples, selective illumination (as further described below in connection with FIG. 4B) is made available to a user, as illustrated by flashlight circle 218. Here, flashlight circle 218 may be manipulated by a user using a mouse or other input/output implement to move it about interface 200 in order to illuminate darkened features such as functionality control 216. As selective illumination (i.e., flashlight circle 218) is moved onto dimmed areas, the darkened features of interface 200 are revealed as though overlay window 202 is fully transparent and not dimmed. In other examples, flashlight circle 218 and selective illumination may be implemented differently and are not limited to the above descriptions.

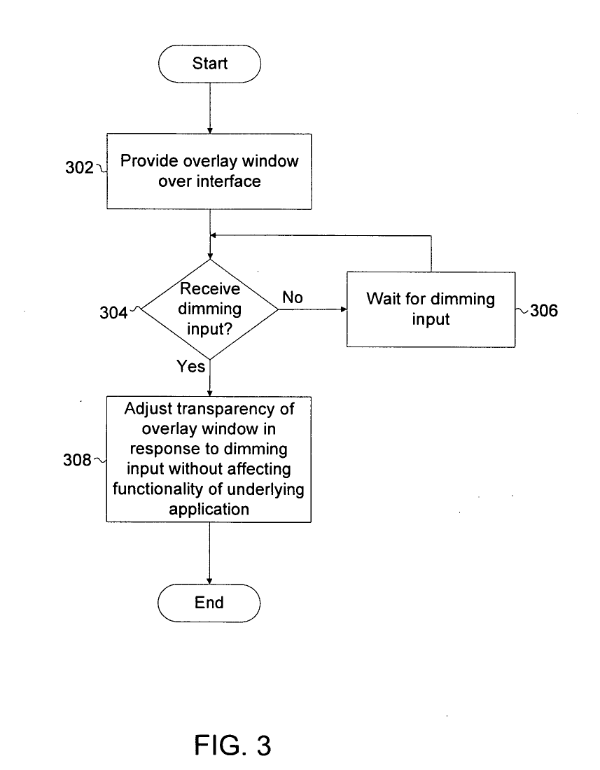

FIG. 3 illustrates an exemplary process for isolating an image, in accordance with an embodiment. Here, an overlay window is provided over an interface, in accordance with examples such as those described above in connection with FIG. 2 (302). System 100 (FIG. 1) waits for dimming input to be received (i.e., from a user or system-generated input resulting from parameters or rules that may be used to implement automatic dynamic selective isolation) (304). In some examples, dimming input may be user or system-specified input, such as a user pressing a key on a keyboard, manipulating a widget on a screen to modify the transparency or opacity of an overlay window, providing audio (e.g., voice) commands through an analog-to-digital voice decoder specifying dimming commands, and others. Still other examples of dimming input may include system-specified input such as rules, parameters, or other guidelines for implementing automatic logic that governs the transparency level of the overlay window to isolate one or more images while not affecting underlying functionality of the application available to a user. If dimming input is not received, then system 100 waits for dimming input (306). When dimming input is received, the transparency level of the overlay window is adjusted in response to the dimming input (308). Adjustments to the transparency level of the overlay window may include increasing the degree of opacity of the overlay window to various degrees, which may appear as though “background lighting” is being raised or dimmed in an interface. By modifying the transparency level of the overlay window, images may be isolated so that a user can preview the image while maintaining use of functionality in the underlying editing tool, authoring program, document, or other application.

FIG. 4A illustrates an exemplary process for providing an overlay window, in accordance with an embodiment. Here, an image on an interface (i.e., screen, display, and the like) is identified (402). Once identified, the image is highlighted by building a list of rectangles associated with the image (404). In other examples, a list of other shapes may be built. The described techniques may be implemented using ovals, circles, polygons, and other shapes to highlight an image (or other type of content). In some examples, shapes may be used to highlight content based on the shape of the content (e.g., image, text, video, graphics, and others). FIG. 4B further describes the process of adjusting the transparency of an overlay window in response to dimming input.

FIG. 4B illustrates an exemplary process for adjusting transparency of an overlay window, in accordance with an embodiment. Here, a cutout is made in the overlay window for an image identified in the above-described process of FIG. 4A (406). In some examples, the size, position, and shape of the cutout is based on the size, position, and shape of the rectangle associated with the image underneath the cutout. The process described may be implemented using ovals, circles, polygons, and other shapes to highlight an image (or other type of content). In some examples, shapes may be used to highlight content based on the shape of the content (e.g., image, text, video, graphics, and others). In other examples, once the cutout has been placed, a stroke (e.g., a single pixel colored (e.g., white, black, grey, and others) line drawn around the perimeter of the image) may be made to further highlight the image (408). In other examples, a stroke may be omitted, but instead used if a user intends to identify and highlight content. After a cutout for the image has been determined, the transparency of the overlay window is adjusted based on the dimming input received (410). The opacity of the overlay window may be animated to provide for different effects, such as gradual dimming or raising of lights. Further, underlying application functionality is still enabled regardless of the degree of perceived dimming or lighting. In other words, the controls, features, icons, menus, fields, buttons, and other interface controls of the current application are still present, even if the transparency of the overlay window has been completely adjusted to black. Other colors may be used to dim or shade the overlay window and is not limited to black. For example, white may be used instead of black in order to “white out” the background content surrounding images on a webpage. In another example, the color of the overlay window may be manually or automatically determined based on the background color of the image being isolated. The RGB parameters of the background color may be determined if, for example, an image is a picture taken of a person standing against a black background (i.e., a picture taken in the evening). In this case, when dimming input is provided, the transparency of the overlay window may be adjusted so that as selective dimming is increased, the overlay window becomes a greater, more intense degree of white. In other examples, different colors and animation effects may be implemented.

Alternatively, another technique for dimming various user interface elements (e.g., images, text, text blocks, graphics, video, and other types of content used to construct an interface display) on a screen may be implemented by drawing the elements in a darkened fashion. In some examples, elements that are not highlighted or isolated may be “dimmed” by drawing them in a darkened fashion by adjusting the pixel colors of the elements being drawn. Images (or other types of content) that are meant to be isolated and not dimmed may be drawn in a non-darkened fashion. Thus, when the elements are drawn, those intended for isolation remain visible or “lit” and those not highlighted or intended for isolation are drawn in a darkened manner. An overlay window, in some examples, is not used and system 100 (FIG. 1) may be implemented without overlay module 102, but instead logic may be included with other modules of system 100 to provide logic that performs the above-described process. The above-described technique as an alternative process for presenting an interface that appears to have isolated certain content (e.g., images) and dimming the rest. Further, incremental changes to the color of “darkened” content may be used to animate the dimming effect, in response to user or system input indicating a dimming level for the interface. In other examples, other processes may be implemented or the described techniques may be varied and are not limited to the descriptions provided above.

Other alternatives for selective dimming for use with dynamic isolation of images may include optional functionality for selective illumination (e.g., spot or motion-sensitive illumination). In some examples, illumination of darkened (i.e., partial or fully-darkened or completely opaque) elements and content on an interface may be performed by providing a widget that allows a user to selectively illuminate various portions of a darkened screen. Under direct user control, a “flashlight” (hereafter “flashlight”) may be directed to provide illumination on an area of the interface. Selective illumination may be implemented to provide a visual effect that is substantially similar to using a flashlight on an area of a darkened room. Additionally, selective illumination may be implemented as a motion-sensitive tool. A flashlight may follow a mouse, cursor, or other graphical icon as it moves about an interface, illuminating areas as the mouse, cursor, or other user-directed graphical icon moves over them. After the flashlight passes over a given area, the illuminated content may gradually fade back to a darkened state (e.g., black), by increasing the transparency of an overlay window, redrawing onscreen elements in a darkened manner, and the like.

In other examples, a widget (e.g., a displayed or on-screen visual element, icon, or graphic that, when a user interacts with, invokes another routine, application, or input) may be invoked by a user to enable selective illumination. Examples of widgets may include graphical representations of an on/off button, adjustment scale, switch, sliding bar, drop-down menu, arrow, and the like. Widgets may also be optionally provided in an application to allow a user to enable/disable (i.e., turn on or turn off) selective illumination that, when used, appears as though a flashlight is being used to illuminate darkened elements or content surrounding the isolated image. The shape, diameter, intensity, persistence or illumination delay (i.e., as the flashlight moves on a screen, darkened elements remain illuminated despite the flashlight having moved on to other darkened elements or content, but after a time delay, the illuminated areas gradually dim to the transparency level of the overlay window or the darkened state of other darkened elements on the interface), movement, and other parameters or characteristics of a flashlight may be varied based on system or user-input. In other words, selective illumination parameters may be adjusted by a user or set, for example, as a system default when enabled by an application executing processes such as those described above.

As an example, if an overlay window has been rendered opaque, the selective illumination may be used to illuminate portions of the darkened overlay window. Alternatively, darkened elements may be redrawn in a non-darkened presentation (i.e., redrawing the objects as though an overlay window is fully transparent, redrawing portions of a darkened element or content as the flashlight moves over it, or adjusting pixel data associated with on-screen elements to enable an effect of selectively illuminating darkened elements or content). A flashlight or other implementation of selective illumination allows a user to focus on content that was previously presented in an unfocused (i.e., darkened) area or portion of an interface. In other examples, selective illumination and motion-sensitive illumination may be implemented differently and are not limited to the above-described techniques.

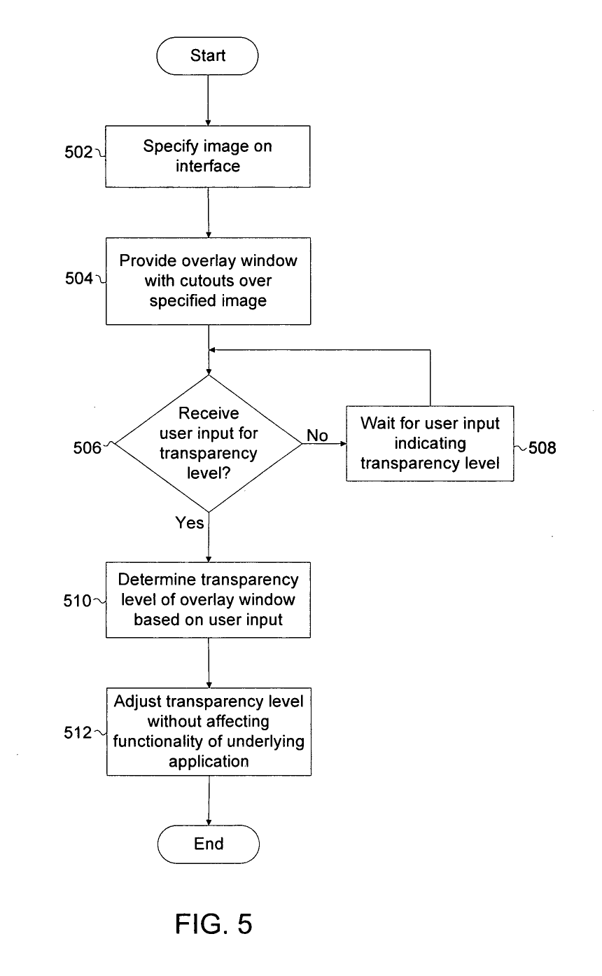

In some examples, another on-screen widget may be used to receive user input (i.e., dimming input). Using a mouse, a user can left, right, or center click or scroll to activate animation of the opacity of the overlay window. Animated dimming effects may also be initiated by receiving user input through an I/O device such as a keyboard, IR, touch screen, or other similar tool. For example, by pressing a given key (e.g., “L”, “F10”, and others), the transparency of the overlay window may be adjusted in percentage increments (e.g., 10%, 20%, 30%, 40% opacity, etc.). An adjustment to 100% opacity is substantially equivalent to completely blocked. If black is chosen as the overlay window color, then a 100% opacity adjustment may result in a black “background” with images appearing and not surrounding application tools, buttons, and the like. However, the underlying functionality of the application tools, buttons, and the like is maintained. FIG. 5 illustrates an alternative implementation of a process for dynamically isolating an image in a non-interruptive manner.

FIG. 5 illustrates an alternative exemplary process for isolating an image, in accordance with an embodiment. Here, an image is specified on an interface (e.g., interface 202 (FIG. 2)) (502). An overlay window is placed over the specified image, including a cutout placed over the image (504). In some examples, determining a cutout for an image may be performed in accordance with the above-described processes in FIGS. 4A-4B. A determination is made as to whether user input for the transparency level of the overlay window (i.e., dimming input) has been received (506). If user input is not received, then system 100 (FIG. 1) waits for user input for the transparency level of the overlay window (508).

If user input is received for the transparency level of the overlay window, then the transparency level may be determined using the input (510). Transparency levels of the overlay window may also be determined using other inputs, including system-specified or automatically-generated input. Once determined, the transparency level of the overlay window is adjusted without affecting the underlying functionality of the application (512). Data communicated between system 100 (FIG. 1) and the underlying application may be implemented using API module 110. Data from API module 110 helps to determine the transparency level and animation effects of the overlay window without affecting the functionality of the underlying application. For example, document authoring, editing, creative, or digital imaging applications such as those developed by Adobe Systems Incorporated of San Jose, Calif. may be used with the above-described techniques in order to isolate images while ensuring users are able to continue using the application. In some examples, if the transparency level of the overlay window has been adjusted to 100% opacity (i.e., completely “black” or solid thus preventing any objects (e.g., buttons, fields, icons, or other graphical elements) apart from images on the page from showing), users may continue to select function underneath the overlay window to further edit the images.

Here, specifying an image may include receiving information from API module 110 by highlight module 104 (FIG. 1) to draw rectangles, ovals, circles, polygons, or other shapes to highlight images on interface 200 (FIG. 2). Although highlight module 104 is described is drawing rectangles around images or other content to be highlighted, other shapes such as ovals, circles, polygons, and other shapes may be used and are not limited to the description provided in connection with FIG. 1. API module 110 provides data associated with the position, size, and changes, if any, to rectangles around the images. If the images change in appearance or the user switches to another application that causes changes in the appearance of the images, then data associated with the changes may be communicated via API module 110 to highlight module 104, which builds a current list of rectangles that are used to determine what cutouts to place on overlay window 202. In some examples, API module 110 may be called as changes occur in order to communicate data associated with changes occurring in the appearance of images on overlay window 202. In other examples, changes may be handled differently and are not limited to the techniques described above.

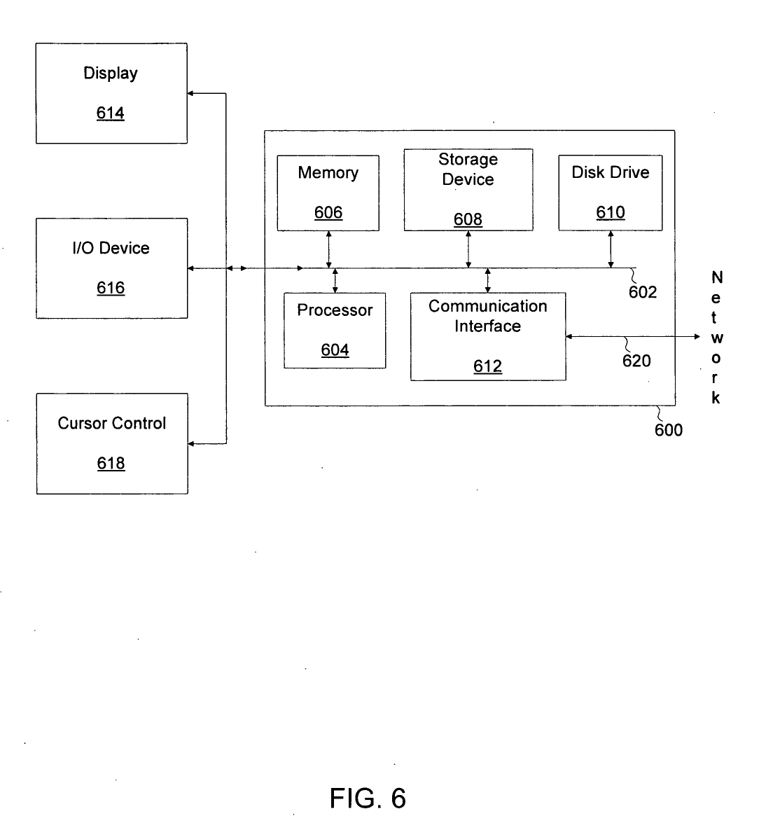

FIG. 6 is a block diagram illustrating an exemplary computer system suitable for dynamic non-interruptive image isolation, in accordance with an embodiment. In some embodiments, computer system 600 may be used to implement computer programs, applications, methods, processes, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some embodiments of the invention, computer system 600 performs specific operations by processor 604 executing one or more sequences of one or more instructions stored in system memory 606. Such instructions may be read into system memory 606 from another computer readable medium, such as static storage device 608 or disk drive 610. In some embodiments, hard-wired circuitry may be used in place of or in combination with software instructions to implement the invention.

The term “computer readable medium” refers to any medium that participates in providing instructions to processor 604 for execution. Such a medium may take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 600. According to some embodiments of the invention, two or more computer systems 600 coupled by communication link 620 (e.g., LAN, PSTN, or wireless network) may perform the sequence of instructions to practice the invention in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

Although the foregoing embodiments have been described in some detail for purposes of clarity of understanding, implementations of the above-described system and techniques is not limited to the details provided. There are many alternative implementations and the disclosed embodiments are illustrative and not restrictive.

1. A method, comprising:
providing an overlay window over an interface displaying an image, the interface being configured to display the image and the overlay window being configured to have a cutout disposed over the image, wherein a non-cutout portion of the overlay window extends over a portion of the interface including a control element for an application;
receiving dimming input, the dimming input being associated with the application; and
adjusting transparency of the non-cutout portion of the overlay window in response to the dimming input, the transparency being determined without affecting the application, wherein said adjusting comprises fully or partially obscuring the portion of the interface including the control element for the application, wherein the control element remains functional after said adjusting.

2. The method recited in claim 1, wherein the dimming input indicates a degree of shading of the overlay window.

3. The method recited in claim 1, wherein the dimming input is provided using a keyboard.

4. The method recited in claim 1, wherein the dimming input is provided using a widget.

5. The method recited in claim 1, wherein receiving dimming input further comprises sending data from the interface to the application, wherein the image is displayed in a document within the application.

6. The method recited in claim 1, wherein the dimming input further comprises a parameter used to determine a size of the cutout.

7. The method recited in claim 1, wherein adjusting the transparency of the overlay window further comprises communicating data associated with the image and the interface to determine the transparency.

8. The method recited in claim 1, wherein adjusting the transparency of the overlay window further comprises dimming the overlay window and isolating the image using data from the application.

9. A method, comprising:
specifying an image on an interface associated with an application, including drawing a perimeter of the image;
providing an overlay window over the interface, the overlay window having a cutout disposed over the image, wherein the cutout is determined based on the perimeter, wherein a non-cutout portion of the overlay window extends over a portion of the interface including a control element for the application;
receiving a user input associated with transparency of the overlay window;
determining the transparency of the overlay window, the transparency being adjusted based on the user input without affecting the functionality of the application, wherein the transparency is adjusted to fully or partially obscure the portion of the interface including the control element for the application, wherein the control element remains functional after said adjusting; and
subsequent to the portion of the interface including the control element being fully or partially obscured, receiving a user input associated with the control element.

10. The method recited in claim 9, wherein the image is configured for display on the interface.

11. The method recited in claim 9, wherein specifying the image further comprises drawing a stroke around the perimeter of the image.

12. The method recited in claim 11, wherein the stroke is used to determine a size and position of the cutout.

13. The method recited in claim 9, wherein receiving a user input associated with the transparency of the overlay window further comprises receiving the user input from a widget in data communication with the application.

14. A method, comprising:
displaying an interface comprising content displayed on a background; and
receiving dimming input associated with the interface, the dimming input being used to dim the background without dimming the content, wherein the background includes a control element of an application that remains functional subsequent to the background being dimmed.

15. A system, comprising:
a memory configured to store data associated with an image; and
a processor configured to
provide an overlay window over an interface displaying the image, the interface being configured to display the image and the overlay window being configured to have a cutout disposed over the image, wherein a non-cutout portion of the overlay window extends over a portion of the interface including a control element for an application,
receive dimming input, the dimming input being associated with an application, and
adjust the transparency of the non-cutout portion of the overlay window in response to the dimming input to fully or partially obscure the portion of the interface including the control element for the application, the transparency being determined without affecting the application so that the control element remains functional after said adjusting.

16. A system, comprising:
a memory configured to store data associated with isolating an image; and
logic configured to:
specify the image on an interface associated with an application including drawing a perimeter of the image,
provide an overlay window over the interface, the overlay window having a cutout disposed over the image, wherein the cutout is determined based on the perimeter, wherein a non-cutout portion of the overlay window extends over a portion of the interface including a control element for the application,
receive a user input associated with transparency of the overlay window,
determine the transparency of the overlay window, the transparency being adjusted based on the user input without affecting the functionality of the application, wherein the transparency is adjusted to fully or partially obscure the portion of the interface including the control element for the application, wherein the control element remains functional after said adjusting, and
receive, subsequent to the portion of the interface including the control element being fully or partially obscured, a user input associated with the control element.

17. A computer program product embodied in a computer readable storage medium storing computer instructions for:
providing an overlay window over an interface displaying the image, the interface being configured to display the image and the overlay window being configured to have a cutout disposed over the image, wherein a non-cutout portion of the overlay window extends over a portion of the interface including a control element for an application;
receiving dimming input, the dimming input being associated with the application; and
adjusting transparency of the non-cutout portion of the overlay window in response to the dimming input, the transparency being determined without affecting the application, wherein said adjusting comprises fully or partially obscuring the portion of the interface including the control element for the application, wherein the control element remains functional after said adjusting.

18. A computer program product embodied in a computer readable storage medium storing computer instructions for:
specifying the image on an interface associated with an application, including drawing a perimeter of the image;
providing an overlay window over the interface, the overlay window having a cutout disposed over the image, wherein the cutout is determined based on the perimeter, wherein a non-cutout portion of the overlay window extends over a portion of the interface including a control element for the application;
receiving a user input associated with transparency of the overlay window;
determining the transparency of the overlay window, the transparency being adjusted based on the user input without affecting the functionality of the application, wherein the transparency is adjusted to fully or partially obscure the portion of the interface including the control element for the application, wherein the control element remains functional after said adjusting; and
subsequent to the portion of the interface including the control element being fully or partially obscured, receiving a user input associated with the control element.
